(19) United States
(12) Patent Application Publication
(10) Pub. No.: US 2004/0114582 A1
(43) Pub. Date: Jun. 17, 2004

(54) Electronic switching circuit and method for a communication interface with buffer storage

(76) Inventor: Franz-Josef Gotz, Heideck (DE)

Correspondence Address: HENRY M FEIEREISEN, LLC, 350 FIFTH AVENUE, SUITE 4714, NEW YORK, NY, 10118, US

(21) Appl. No.: 10/471,653

(22) PCT Filed: Mar. 11, 2002
(86) PCT No.: PCT/DE02/00850

(30) Foreign Application Priority Data
Mar. 22, 2001 (DE) 101 14 390.7
Aug. 22, 2001 (DE) 101 41 187.1

(51) Int. Cl. H04L 12/50

(52) U.S. Cl. 370/360

(57) ABSTRACT

The invention relates to an electronic switching circuit for a scalable communication interface between a first communication connection (16) having a first transmission cycle (17) with a first length and a second communication connection (12) having a second transmission cycle (13) with a second length, and comprising a receiving list (5, 15, 19, 33) for the first transmission cycle and a sending list (6, 14, 18, 31) for the second transmission cycle, wherein an element of the sending list is assigned to a data message (20, 21, 22, 23, 24, 25, 26, 27, 28) received in accordance with the receiving list, and additionally comprising a receiving buffer (4, 34) a sending buffer (7, 30) and a storage buffer (8) for data messages fully received according to the receiving list and for data messages sent according to the sending list, wherein both the receiving buffer as well as the sending buffer are combinable with the storage buffer.

The invention relates to a method and an electronic switching circuit for a communication interface having buffer storage.

Many methods and systems for the implementation of communication connections between the stations of a data network are known from the state-of-the-art. Bus systems that enable each station to address every other station directly over the bus system are wide spread. Furthermore, switched data networks are known in which the so-called “point-to-point” connections are implemented, which means that one station can only indirectly reach any other station of the switched data network, through a corresponding forwarding of the transmitted data through one or more coupling points.

Data networks enable the communication among multiple stations through the Internet, i.e. connection of the individual stations with each other. Communication refers hereby essentially to the transmission of data between the stations. The data to be transmitted is hereby sent as data messages, i.e., the data is assembled into several packets and sent in this form over the data network to the corresponding receiver. Thus, they are also referred to as data packets. Therefore the term “data transmission” is generally used as a synonym for referring to the afore-mentioned transmission of data messages or data packets.

The Internet itself is broken up into switched high-performance data networks, especially Ethernet networks, for example, so that at any one time between two respective stations at least one coupling point is switched that is connected to both stations. Each coupling point can be connected to more than two stations. Each station is connected to another station, though not directly, through at least one coupling point. Stations are computers or stored-program control systems (SPS), for example, or other types of machines, particularly those that exchange data with other machines to operate.

In distributed automation systems, in the area of mechanical engineering, for example, designated data must come to a designated station and be used by the receiver at a designated time. This is referred to as real-time-critical data or data processing, wherein an untimely arrival of data at the designated place leads to undesired results for the station. According to the Technical Abstract: IEC 61491, EN61491 (http://www.sercos.org/english/index.htm), successful real-time-critical data operation can be assured in distributed automation systems pursuant to this SERCOS interface specification.

Likewise, it is known in the state of the art to use a synchronous-time communications system having an equal-length characteristic in one such automation system. Hereafter, a system is understood to have at least two stations that are connected over a data network for the purpose of reciprocal exchanges of data, or rather the reciprocal transmission of data to each other.

This results in cyclical data exchange in equal-length communication cycles that are prescribed by the communications timing used by the system. Stations are, for example, centralized automation apparatus; programming, planning or control apparatus; peripheral apparatus such as, for example: input and output assemblies, drivers, actuators, sensors, stored-program controller systems (SPS) or other control units, computers or machines that exchange electronic data with other machines, especially those that process data from other machines. Hereafter, control units are understood to be limiters or drivers of any sort. Among the data networks are bus systems such as field bus, process field bus, Ethernet, industrial Ethernet, FireWire, or even PC internal bus systems (PCI), etc.

In general, automation components (for example controllers, drivers . . . ) communicate with a cyclically-timed communications system through an interface. One level of automation component operation, the “fast-cycle,” for example a controller's position management, or a driver's torque management, etc., is synchronized with the communications cycle. They are set to the communications timing for that reason. However, algorithms of low-performance “slow-cycle” automation devices, for example temperature control, can only communicate with other components such as binary switches for blowers, pumps, etc., using this communications timing, even though a longer cycle time would be adequate. By the use of only one communications time for the transmission of all information in a system, heavy demands are made on the bandwidth of the communications channel.

System components using only one communications system, or rather one communications cycle, the “fast-cycle,” for communication with each process, or rather each automation level, wherein all relevant information is transmitted using that speed, are known in the state of the art. Data that are only needed in the slow-cycle can be staggered so as to limit their bandwidth requirement, by using auxiliary protocols, for example. That means an additional software expense for the automation components. Furthermore, the bandwidth of the bus as well as the shortest possible communication cycle for the entire system is determined by the lowest-performance components.

The invention is based on the object to provide an improved method and an improved electronic switching circuit for a communication interface as well as corresponding computer software.

The object upon which the invention is based upon is attained by the features of the respective independent claims.

The invention permits a single communication interface to be implemented between differently performing cyclically-pulsed communication connections. The invention makes it possible for the characteristics of respective applications in an automation system to be adjusted, to operate different-performing communication connections therein for example. By means of the invention, a low-performance interface can be implemented for communications for slow input and output assemblies, so that the assemblies can communicate with the assigned operational levels of the controller through a corresponding interface, for example.

A particular advantage of the invention is seen in that it allows data messages from different communication connections having different transmission rates and/or different communication cycles to be brought together at the level of a linking node, without needing a higher logical level application program for that purpose. In particular this is advantageous for a communications switch, a so-called ASIC switch, whereby this communications switch can include multiple separate ports for different communication connections.

A further particular advantage of the invention is that it makes possible a more consistent exchange of real-time data in a synchronous communications system made up of different sub-networks that have respective different transmission rates and/or communication cycles.

It is crucial for a consistent transmission of real-time data, that it is assigned each time to a given communication cycle, and that is also true across the communication interface between individual sub-networks. The invention permits such a fixed assignment of real-time data to particular communication cycles across the boundaries of sub-networks.

In one preferred embodiment, the invention provides the consistent data exchanges through a storage buffer, that is, the data from the receiving port is always written into the common storage buffer and the data is called from the storage buffer by the sending port at the corresponding sending time point. Additionally, it can provide a sending buffer and a receiving buffer for each port. The capacity of the sending and receiving buffers must be at least sufficient for a data message to have the maximum message length, in that case. As soon as the entire data message is received, the data is copied into the storage buffer. In sending data, the data is copied into the sending buffer of the sending port.

In a further preferred embodiment of the invention, it is guaranteed by an access controller for the common storage buffer that no conflict can occur in the storage buffer during reading and writing.

It is of particular advantage, that only one standard communication interface has to be implemented in a linking node and that no additional instance of data copying is necessary between different communication interfaces.

A further advantage of the invention is, that it allows an automation system to be realized that includes different performing sub-networks, in particular for use by and in packaging machines, presses, plastic-coating machines, textile machines, printing machines, machine tools, robots, conveyor systems, woodworking machines, glass working machines, ceramics processing machines, as well as hoists.

A preferred embodiment of the invention will now be explained in greater detail with reference to the drawings. It is shown in:

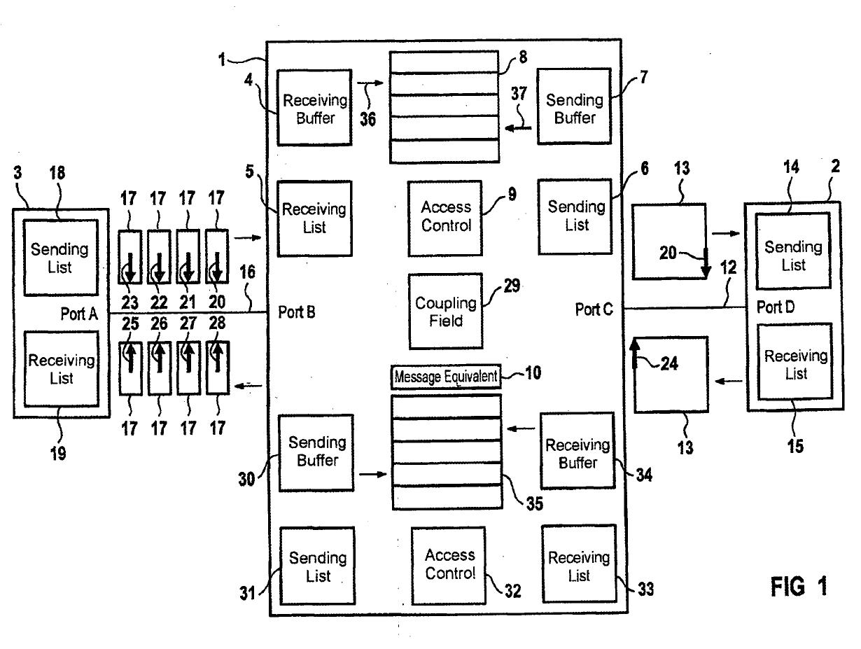

FIG. 1 a block diagram of an embodiment of an electronic switching circuits and corresponding communication connections between two sub-networks having different performance specifications in accordance with the invention,

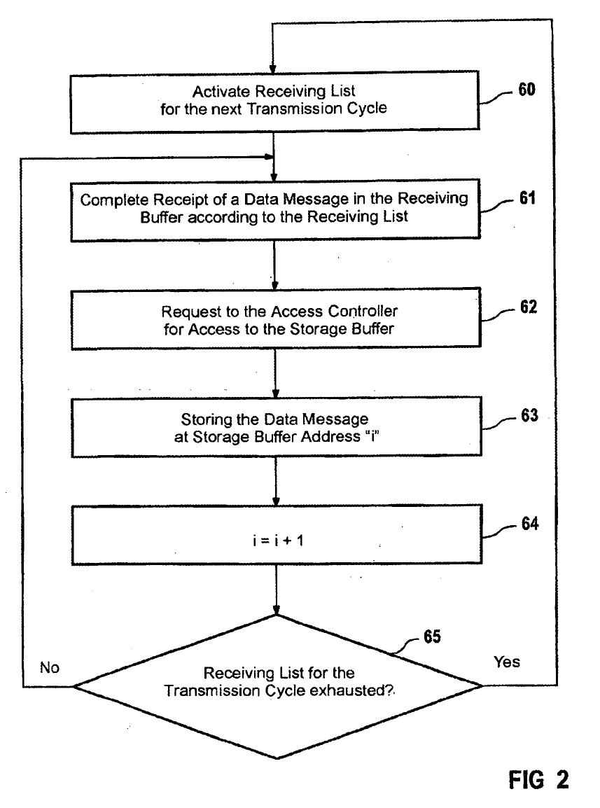

FIG. 2 a flow diagram of preferred embodiment of a receiving method in accordance with the invention,

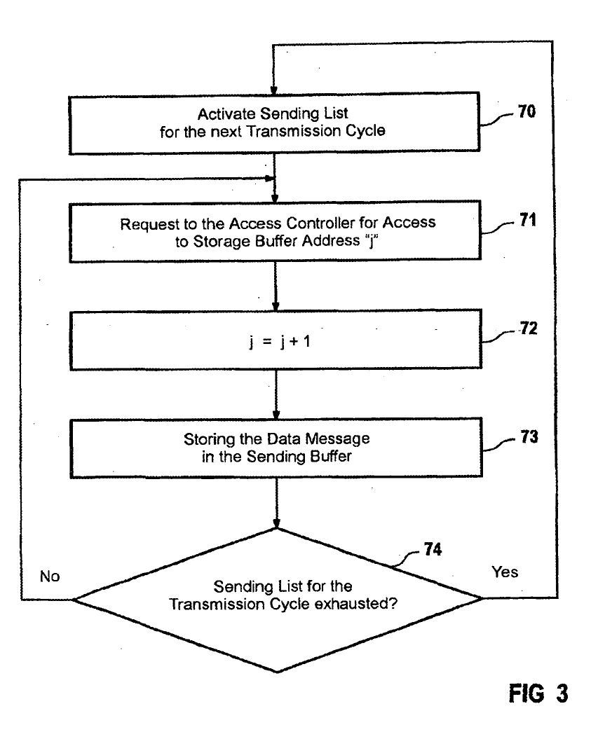

FIG. 3 a flow diagram of preferred embodiment with regard to the sending of a data message from lower-performance to higher-performance networks,

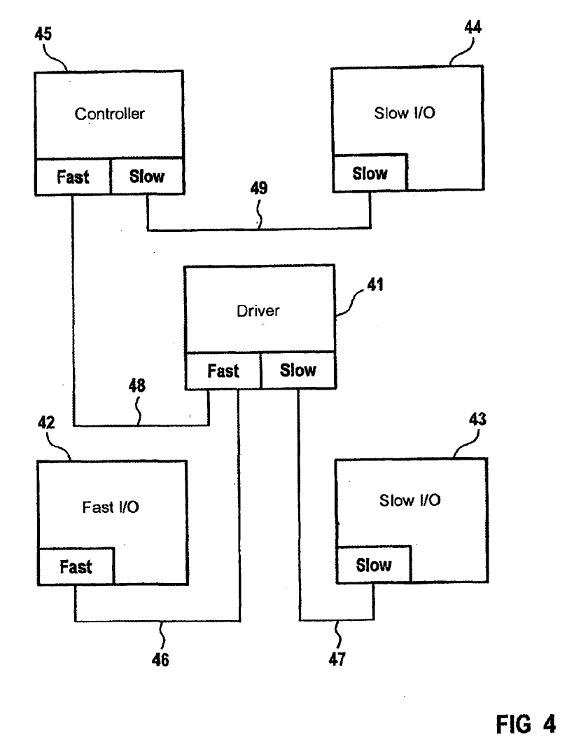

FIG. 4 a preferred embodiment of an automation system in accordance with the invention,

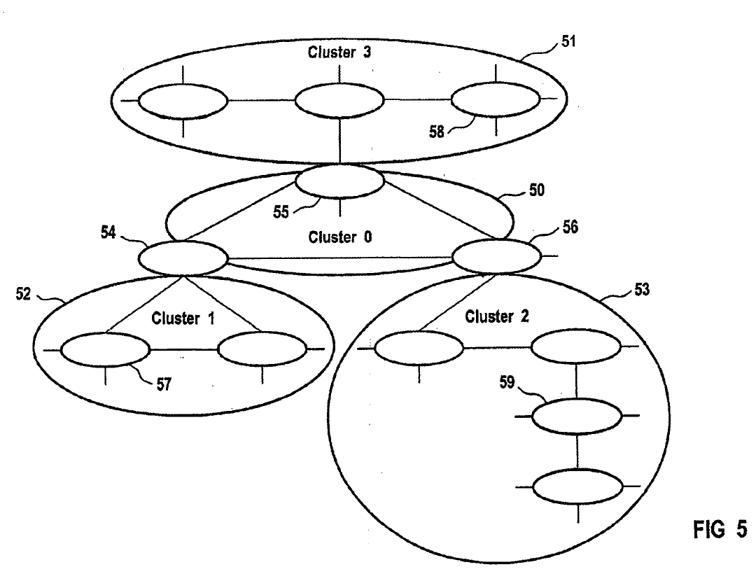

FIG. 5 an exemplified embodiment of an automation system having sub-networks having different performance specifications.

FIG. 1 shows an electronic switching circuit 1 that serves as the linking node between node 2 and node 3.

The linking node 1 has the two communications ports, port B and port C.

A receiving list 5 is assigned to the port B. The receiving list 5 determines which data messages to receive at different time points at port B from the various other nodes of the communications system. The time point and the address of the data messages are determined in advance in this way; this changes solely for the data messages respectively carrying operational data.

Furthermore, the port B is assigned to a receiving buffer 4. The receiving buffer serves as buffer memory for the entire receipt of at least one data message. Thus, the receiving buffer 4 has a size that is at least sufficient for the accommodation of one individual data message having the maximum message length.

The port C, which is in a synchronous communications system, has a sending list 6 that defines which data message is to be sent to which receiver at which point in time from Port C of the linking node 1. A sending buffer 7 is assigned to port C that serves for the buffering of one of the data messages to be sent. Like the receiving buffer 4, the sending buffer 7 must also have a size that is at least sufficient for accommodating one individual data message having a predetermined maximum length for a message.

A storage buffer 8 is located between the receiving buffer 4 and the sending buffer 7. The storage buffer 8 serves for the buffering of entire received data messages. So that both the receiving buffer 4 and the sending buffer 7 can access the storage buffer 8, the corresponding accesses are controlled by an access controller 9, a so-called “arbiter.”

As soon as a data message is entirely entered into the receiving buffer 4, a request to copy the entire received message into the storage buffer 8 is presented to the access controller 9. The storage buffer 8 is divided into different memory areas, by rows, for example. Individual memory areas are identified by a writing pointer 36, as well as a reading pointer 37.

The storage of the data message completely received in the receiving buffer 4 in the memory location of the storage buffer 8 that is identified by the current position of the writing pointer then follows. After the writing operation in the corresponding memory location, the position of the writing pointer 36 is incremented so that the writing pointer 36 then points to the next free memory location.

As soon as the reading pointer 37 points to the memory location of a previously stored data message, this is pushed out of the storage buffer 8 into the sending buffer 7 to be sent out from there in accordance with the sending list 6. After the transfer of the affected data message out of the storage buffer 8 into the sending buffer 7, the reading pointer 37 corresponding to the operative sending list 6 is incremented.

According to an alternative embodiment, the sending list 6 contains one address in the storage buffer 8 from which the data message to be sent is called, for each item to be sent. Correspondingly, this alternative embodiment can also include the control structure of the receiving list, having an address in the storage buffer 8 for each item to be received, at which a corresponding entire received data message should be stored.

The linking node 1 is connected through a communication connection 12 to a node 2. The communication connection 12 involves a connection having a relatively low data rate and a relatively long transmission cycle 13, also referred to as framework or “frame.”

The communication connection 12 connects port C with a port D of the node 2. A sending list 14 and a receiving list 15 which define the synchronous transmission of data messages, that is, across the communication connection 12, are assigned to the port D.

Correspondingly, the port B of the linking node 1 is connected to a port A of the node 3 by a communication connection 16, whereby the communication connection 16 provides a connection having a relatively high data rate and a relatively short transmission cycle 17.

In the port A of the node 3, there is once again a sending list 18 and a receiving list 19 for the synchronous transmission of data messages to or from node 3, respectively.

Communication flows over the communication connections 12 and 16 in periodically-repeated transmission cycles 13 and 17, respectively, which themselves can be divided into respective time slots. During one of the transmission cycles 13 or 17, respectively, the corresponding receiving and sending lists are processed so that different data messages are assigned to the respective time slots in a transmission cycle.

In the example seen in FIG. 1 four time-consecutive transmission cycles 17 are shown, in which one or more respective data messages are transmitted at a time. For the sake of clarity, only one data message 20, 21, 22 or 23, respectively, is shown for each transmission cycle 17.

Basically, the communication connections 12 and 16 do not need to be synchronized with each other in the linking node 1 for future applications employing the “Store-and-Forward” method, that is to say, the beginning of the transmission cycles 13 and 17 can have a phase shift. Likewise, the length of the of the transmission cycles 13 and 17 can have any value, i.e., there is no restriction to a same message length or a whole-number relationship. However, in synchronous communications systems the maximum length of data messages must be defined such that, in each instance, a corresponding data message can be transmitted within one transmission cycle 13 or 17, so that the consistency of data, particularly of real-time data, is guaranteed.

In a second alternative example, a data message 24 is sent from the node 2 according to its sending list 14 in the transmission cycle 13 over the communication connection 12 from its port D to the port C of the linking node 1. That data message 24 is received by port C of the linking node 1 according to its receiving list 33 and stored in the receiving buffer 34.

The linking node 1 then sends the data messages 25, 26, 27, and 28 in the next transmission cycles 17 from that port B according to the sending list 31. It can occur in this way because a copy of the data message 24 acts as the data messages 25 to 28, respectively. The requirements of the receiving list 19, which anticipates a data message in each data slot of the transmission cycle 17, are satisfied in this manner and way.

An alternative possibility is the storing of a message equivalent that carries no useful information in the memory 10. In that case, only one of the messages 25 to 28 is a copy of the message 24, the data message 25 for example, while the other data messages 26 to 28 in the memory 10 are respective copies of the message equivalent. This process can, for instance, be carried out under the supervision of the controller 32.

Altogether, therefore, for an n-fold transmission of a data message from node 3, a four-fold transmission for example, this data message is sent from the node 1 to node 2 “m” times wherein m<n, preferably m=1 as in the observed example.

On the other hand, for an n-fold transmission over the low-performance communication connection 12, this data message is either repeated m-times, that is to say a four-fold repetition of one single transmission, as in the referenced example, or else the data message sent is transmitted only once and it is followed by an additional transmission of m−1 data-message equivalents.

Furthermore, the linking node 1 has a coupling field 29 over which communication connections between ports B and C, as well as with other ports the linking node 1 not shown in FIG. 1 can be made as needed.

The linking node 1 itself can also be an integral part of an automation device.

FIG. 2 shows a corresponding flow diagram for the transmission of a data message to a port of the linking node. In step 60, the receiving list of the relevant port is activated for the next transmission cycle of the respective communication connection. A complete transmission of a data message via the communication connection in accordance with the sending list follows in step 61. This message is briefly stored in the sending buffer.

A request to the access controller for access to the storage buffer follows in step 62. After the access controller has provided a corresponding signal to the storage buffer, the corresponding data message is stored in the storage buffer in a memory location having the address “i” in step 63. The address “i” is hereby identified by a storage buffer writing pointer.

This address “i” is incremented in step 64, so that the writing pointer points to the next free memory location in the storage buffer. A so-called “roll over” can also occur in so doing.

If the receiving list for this transmission cycle has already been exhausted by the receipt of this data message, the operational control returns to step 60 to activate the receiving list for the next transmission cycle. In the contrary situation, the operational control returns from decision step 65 to step 61, to receive the next data message according to the same receiving list in the current transmission cycle.

FIG. 3 shows the corresponding situation for transmission from another port of the linking node. At first, in step 70 the respective sending list is activated for the next transmission cycle. In step 71 a request to the access controller for access to the storage buffer is implemented, for transferring the next data message to be sent into the sending buffer and to send it out from there. The relevant memory location at address “j” in the storage buffer is identified by a storage buffer reading pointer. After a corresponding signal from the access controller indicates that the storage buffer memory location having the address “j” is free, the reading pointer is incremented by an amount “k” and the data message is transferred into the sending buffer in step 73.

The amount “k” by which the reading pointer is incremented therein is defined by the sending list. The access controller assures that the reading pointer is not overtaken by the writing pointer and vice versa.

If the sending list for the current transmission cycle has already been exhausted by the transmission of the data message, the subsequent step 74 involves a return back to step 70. Should the opposite be the case, a return to step 71 follows to send out still further data messages in the current transmission cycle in accordance with the sending list.

FIG. 4 shows an explanatory example of an automation system having nodes 41, 42, 43, 44 and 45. A driver acts through the node 41 includes a linking node having both “fast” and “slow” ports. The “fast” port corresponds to port B and the “slow” port corresponds to port C in the linking node 1 in FIG. 1.

The “fast” port of the node 41 is connected to the “fast” port of node 42, corresponding to port A of the node 3 in FIG. 1. The circuit connecting the “fast” ports of the nodes 41 and 42 acts as a high-performance communication connection 46 corresponding to the communication connection 16 of FIG. 1.

The other “slow” port of the node 41 is connected via a low-performance communication connection 47 with a “slow” port of the node 43, corresponding to the communication connection 12 and the port D of FIG. 1, respectively.

Furthermore, an additional “fast” port is connected to a corresponding “fast” port of node 45, a controller for example, over a high-performance communication connection 48. Node 45 has a “slow” port that is connected over a low-performance communication connection 49 with a respective “slow” port of the node 44. The node 45 includes also a linking node of the type shown in FIG. 1. The node 44 has a structure that corresponds to node 2 in FIG. 1.

Therefore, for example, it is possible for a data message to be transmitted between the node 42 and the node 44 in the automation system of FIG. 4, even though the transmission must traverse three communication connections having respective different characteristics.

This can also be used for the linking of different sub-networks, as is explained in further detail with reference to FIG. 5:

The automation system of FIG. 5 has different sub-networks 50, 51, 52 and 53. The sub-networks 50 to 53 have respective different communications systems with different transmission cycles and/or different data rates. Preferably, the transmission cycles of the different sub-networks are synchronized with one another. However, this is not necessarily required.

The corresponding communications systems provide communication for the nodes of one sub-network among one another. It is also possible to provide a communication across the boundaries between sub-networks. For this, the nodes 54, 55 and 56 of the sub-network 50 are constructed as linking nodes and, to be precise, the corresponding linking node 1 of FIG. 1 for example.

Thus, for instance, the node 57 of the sub-network 52 and the node 58 of the sub-network 51 can communicate with each other, even though the sub-networks 51 and 52 have different transmission cycles and/or different data rates. Correspondingly, the node 59 of the sub-network 53 can communicate with the node 57, the node 58 or one of the linking nodes 54 to 56 as well, for example. This allows different already-existing automation systems to network with each other as an integrated system without having to change the components of the existing systems.

Preferably an industrial Ethernet is employed as the communications system for the individual sub-networks, preferably an isochronous real-time Ethernet or a fast real-time Ethernet having different transmission cycles, i.e., different isochronous cycles and/or different data rates. The length of the different transmission cycles can be 500 ms, 10 ms, or 1 ms, for example. The different transmission rates can be 100 MB/s, 10 MB/S and 1 MB/s, for example. A buffering of the real-time data in the corresponding linking node is implemented for the transition from one transmission rate to another.

In summary, the invention pertains to a method and an electronic switching circuit for a scalable communication interface between a first communication connection 16 having a first transmission cycle 17 with a first length and a second communication connection 12 having a second transmission cycle 13 with a second length, and having a receiving list 5, 15, 19, 33, for the first transmission cycle and a sending list 6, 14, 18, 31, for the second transmission cycle, wherein a data message 20, 21, 22, 23, 24, 25, 26, 27, 28, received in accordance with the receiving list, is assigned to an element of the sending list and additionally comprising a receiving buffer 4, 34, a sending buffer 7, 30, and having a storage buffer 8 for data messages fully received according to the receiving list and for data messages sent according to the sending list, wherein both the receiving buffer as well as the sending buffer are combinable with the storage buffer.

1. Electronic switching circuit for a scalable communication interface between a first communication connection (16), which has a first transmission cycle (17) with a first length and a second communication connection (12) having a second transmission cycle (13) with a second length, comprising a receiving list (5, 15, 19, 33) for the first transmission cycle and a sending list (6, 14, 18, 31) for the second transmission cycle, wherein a data message (20, 21, 22, 23, 24, 25, 26, 27, 28) received in accordance with the receiving list is assigned to an element of the sending list, and a receiving buffer (4, 34), a sending buffer (7, 30), and a storage buffer (8) for entire data messages received according to the receiving list and data messages to be sent in accordance with the sending list, wherein both the receiving buffer and the sending buffer can be combined with the storage buffer.

2. Electronic switching circuit according to claim 1, having an access controller (9, 32) for controlling access from the sending and receiving buffers to the storage buffer.

3. Electronic switching circuit according to claims 1 or 2, in which data messages received in the first transmission cycle are stored in successive memory locations of the storage buffer, and having a receiving pointer (36) to the next free memory location for the buffering of completely received data message in the storage buffer

4. Electronic switching circuit according to claim 1, 2 or 3, in which data to be sent is read out of the storage buffer in the second transmission cycle, wherein the respective memory locations are separated from each other by an offset, and including a sending pointer (37) to the respective current memory location having a data message to be sent.

5. Electronic switching circuit according to one of the preceding claims 1 to 4, in which the access controller is configured so that the receiving pointer and the sending pointer do not point to the same memory location.

6. Electronic switching circuit according to one of the preceding claims 1 to 5, wherein the first and the second communication connections have different transmission rates and are not synchronized.

7. Electronic switching circuit according to one of the preceding claims 1 to 6, wherein the first and the second communication connections are synchronous and the first and second lengths are the same or have a whole number relationship to each other.

8. Electronic switching circuit according to one of the preceding claims 1 to 7, in which the sending list is adapted to provide “m” transmissions of a data message within “m” consecutive transmission cycles, after the data message has been received n-times within the first transmission cycle in accordance with the receiving list

9. Electronic switching circuit according to claim 8, in which the data message is sent in accordance with the sending list only once and an additional m−1 data message equivalents are sent in accordance with the sending list within the second transmission cycle.

10. Electronic switching circuit according to one of the preceding claims 1 to 9, in which the first and/or the second communication connections is bi-directional and each of the bi-directional communication connections is associated with a sending list and receiving list, respectively.

11. Electronic switching circuit according to one of the preceding claims 1 to 10, in which the data message involves real-time data.

12. Electronic switching circuit according to one of the preceding claims 1 to 11, wherein the first and second communication connections have an equal-length characteristic.

13. Electronic switching circuit according to one of the preceding claims 1 to 12, wherein the first and second communication connections involves an industrial Ethernet, in particular an isochronous real-time Ethernet or a fast real-time Ethernet.

14. Electronic switching circuit according to one of the preceding claims 1 to 13, having a plurality of input and/or output ports, each associated with a sending and/or receiving list, and having a coupling field (29) for linking one of the ports to one or more of the other ports.

15. Automation system having a plurality of components (41, 42, 43, 44, 45), which are connected with one another through communication connections (46, 47, 48, 49), in which each of the components has an electronic switching circuit according to one of the preceding claims 1 to 14 as an integral part or as supplementary device.

16. Automation system having at least a first sub-network (50, 51, 52, 53) including a first communication connection, and having a second sub-network including a second communication connection and having at least one connection node between the first and second sub-networks with an electronic switching circuit according to one of the preceding claims 1 to 14.

17. Automation system according to claim 13, including a plurality of linking nodes which are connected to one another through a third sub-network (50).

18. Automation system according to claim 13 or 14, in which the various sub-networks have different transmission cycles and/or different transmission rates.

19. Method for operating a communication interface between a first communication connection having a first transmission cycle with a first length and a second communication connection having a second transmission cycle with a second length, comprising the following steps:
a complete receipt of a data message according to one receiving list associated to the first transmission cycle,
b. temporary storage of the completely received data message,
c. sending of the data message according to a sending list associated to the second transmission cycle.

20. Method according to claim 19, in which data messages received in the first transmission cycle are stored in consecutive memory locations of the storage buffer.

21. Method according to claim 19 or 20, in which the data messages to be sent in the second transmission cycle are read out of the storage buffer, wherein the respective memory locations are separated from each other by an offset.

22. Method according to one of the preceding claims 19, 20 or 21, in which by use of the access controller it is assured that during a logical time unit no access occurs to the same memory location of the temporary storage of a completely received data message and its transmission.

23. Method according to one of the preceding claims 19 to 22, in which the first communication connection and the second communication connection have different transmission rates and/or the first and second transmission cycles are asynchronous and/or the first and the second lengths are equal or different, or have any whole number relationship, or not a whole number relationship.

24. Method according to one of the preceding claims 19 to 23, in which a data message is received from a first station of the first communication connection within the first transmission cycle and the data message is sent m-fold within “m” consecutive transmission cycles to a second station on the second communication connection.

25. Method according to claim 24, in which the data message is sent only once in the second transmission cycle and a data-message equivalent is sent m−1 fold in subsequent second transmission cycles.

26. Method according to one of the preceding claims 19 to 25, in which the data message involves real-time data.

27. Method according to one of the preceding claims 19 to 26, wherein the first and second communication connections have an equal-length characteristic.

28. Method according to one of the preceding claims 19 to 27, wherein the first and second communication connections involve each an industrial Ethernet, in particular an isochronous real-time Ethernet or a real-time fast Ethernet.

29. Method according to one of the preceding claims 19 to 28, wherein multiple input and/or output ports, associated each to a receiving and/or sending list, are linked through a coupling field.

30. Method according to one of the preceding claims 19 to 29, in which the first and second transmission cycles have no phase shift.

31. A software program having means for carrying out a method according to one of the preceding claims 19 to 30, in which the software program is carried out by an electronic switching circuit or an automation system.
